(19) United States
(12) Patent Application Publication
(10) Pub. No.: US 2021/0042823 A1
(43) Pub. Date: Feb. 11, 2021

(54) SINGLE-ACTION DIGITAL ASSET COLLATERAL-MULTIPLIER LOAN EQUIVALENT TO A SERIES OF RECURSIVE DIGITAL ASSET COLLATERAL LOANS

(71) Applicant: Salt Blockchain, Inc., Denver, CO (US)

(72) Inventors: Keagan McClelland, Denver, CO (US); Matthew Hill, Centennial, CO (US); Aiden McClelland, Denver, CO (US)

(21) Appl. No.: 16/535,942

(22) Filed: Aug. 8, 2019

(51) Int. Cl. G06Q 40/02; G06Q 40/04

(52) U.S. Cl. CPC G06Q 40/025; G06Q 40/04

(57) ABSTRACT

A digital asset collateral multiplier loan is equivalent to the mathematical limit of a recursive series of discrete digital asset collateralized loans. The digital asset collateral multiplier loan is available according to a single set of loan terms with a single-action request from a borrower. In the recursive series of discrete loans, loan proceeds from each loan in the series is used to acquire digital assets to collateralize the next loan in the series until a termination point is reached, with attendant transaction costs attached to each loan in the series. The digital asset collateral multiplier loan, on the other hand, is a single loan with a single set of loan terms equivalent to a number of iterations of the recursive series, up to an infinite number of iterations. Borrowers avoid delay and cost of multiple loans and a digital asset services provider or lender provides the liquidity needed to acquire the additional digital asset collateral needed to reach equivalent digital asset gains as a discrete set of recursive digital asset collateralized loans.

### BACKGROUND OF THE INVENTION

Borrowers may obtain loans collateralized by digital assets such as bitcoin and other cryptocurrencies. This arrangement provides advantages over conventional lending, which typically relies on credit scores or property perfected as a security interest for the loan. The types of property used to secure a loan are typically not easily liquidated in the case of default (house, car, etc.). With a digital asset collateralized loan, investigation of the borrower's credit history is not required, borrowers with poor credit scores can still obtain access to lending services, and digital assets are much more easily liquidated compared to other types of credit-securing property, thus reducing lending risk. Lenders may agree to disburse loan proceeds only after the digital asset collateral is locked in a digital asset collateral wallet that is not unilaterally spendable by the borrower.

Borrowers who receive loan proceeds from a digital asset collateralized loan may use the loan proceeds to finance any number of activities. One use for the loan proceeds is to acquire additional digital assets. Using digital asset collateral loan proceeds to purchase more digital assets is limited by the amount of the loan proceed funds, which are likely to be a fraction of the digital asset collateral under typical lending terms requiring overcollateralization (e.g., a loan-to-value ratio less than 1.0). This is a repeatable process, and it is possible to borrow “recursively” against digital asset collateral by creating a chain or series of digital asset collateralized loans wherein the loan proceeds of each loan in the series collateralize the next loan. Borrowers often do not engage in this recursive process or are limited in how many iterations of the loan series that can economically be performed due to administrative lending costs. Borrowers therefore are not able to obtain the multiples of the initial digital asset collateral via a series of recursive digital asset collateral loans that would be available if they engaged in the recursive process.

Accordingly, there is a need for a system to collapse a recursive series of digital asset collateralized loans into a single loan with one set of loan terms, thereby multiplying digital assets owned by the borrower, that can be requested and agreed to by a borrower in a single step without the administrative, transactional, and time costs of separately executing all the loans in the recursive series.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example time series of a borrower and lender performing a recursive series of digital asset collateralized loans wherein the loan proceeds of each loan in the series is used to collateralize the next loan until a series termination point.

FIG. 2 includes two charts illustrating two examples of iterations on recursive series of digital asset collateralized loans wherein the loan proceeds of each loan collateralize the next loan in the series.

FIG. 3 is a diagram of a digital asset multiplication loan parameters and a single-action user interface element for requesting a digital asset multiplier loan according equivalent to a recursive mathematical limit series of loans wherein the loan proceeds from each loan collateralize the next loan in the series.

FIG. 4 is a diagram of a digital asset collateralized multiplier loan health status parameters and digital asset collateral wallet interface.

FIG. 5 is a diagram of a digital asset rights management and exercise platform for digital assets held on behalf of a borrower in a digital asset collateral wallet.

FIG. 6 is a block diagram of a relationship between a borrower client and digital asset services provider in an example system for single-action digital asset loan collateral multiplication.

FIG. 7 is an example workflow of a digital asset services provider offering single-action digital asset multiplication loans collateralized by digital assets.

FIG. 8 is an example workflow of user interface elements and actions associated therewith presented to a borrower regarding digital asset multiplication on a loan collateralized by digital assets.

FIG. 9 is an example workflow of a method for automatically collapsing a recursive series of digital asset collateral loans into a single digital asset collateral multiplying loan.

FIG. 10 is an example workflow of a method of automatically multiplying digital asset collateral of a loan.

FIG. 11 is an example system that may be useful in carrying out the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Borrowers with digital asset collateralized loans may choose to use the loan proceeds to acquire more digital assets. If a borrower uses the loan proceeds in this way, the borrower could then use the newly acquired digital assets as collateral on another digital asset collateralized loan. This recursive process can be repeated by taking out loan after loan to form a series or chain, with each new loan collateralized by digital assets purchased with the proceeds of the previous loan in the series. Assuming the loans in the chain have minimum loan-to-value ratio (LTV) requirements, such as an initial LTV less than 1.0, the sum of the series of digital asset collateralized loans converges on a mathematical limit value. In other words, it is possible to increase the initial digital asset collateral by an amount arbitrarily close to the mathematical limit value by increasing the number of iterations of the series. Instead of engaging in a potentially very large number of separate loans, a lender could choose to offer a replacement for the series in the form of a single equivalent loan, the terms of which are the same as a long, or even infinite, recursive series of digital asset collateral loans.

The administrative costs to lenders and borrowers are significant in applying for and originating a recursive series of digital asset collateralized loans wherein each new loan is collateralized by digital assets acquired with the proceeds of the prior loan in the series. A separate loan agreement is agreed to and executed for each loan in the series. The borrower must deposit the digital asset collateral for each loan in a discrete confirmed blockchain transaction. The costs of the separate deposit blockchain transactions are not trivial because each deposit is confirmed on a blockchain which brings its own costs and sometimes slow speed, depending on the current congestion and status of the relevant blockchain network. If a borrower is forming the loan series without help from a lender, then separate loans are necessary because each loan must be done in series such that loan proceeds of a given loan are obtained before those proceeds are available to be used to acquire digital asset collateral to be used on the next loan in the series. Due to stacking transaction costs, the series of recursive loans is likely to be terminated at a point where it is no longer economical to continue the process, even though the mathematical limit of the loan series has not yet been reached. If the costs of originating a new loan are larger than, or close to, the marginal additional digital assets acquired, a borrower is unlikely to continue iterating on the recursive series of loans.

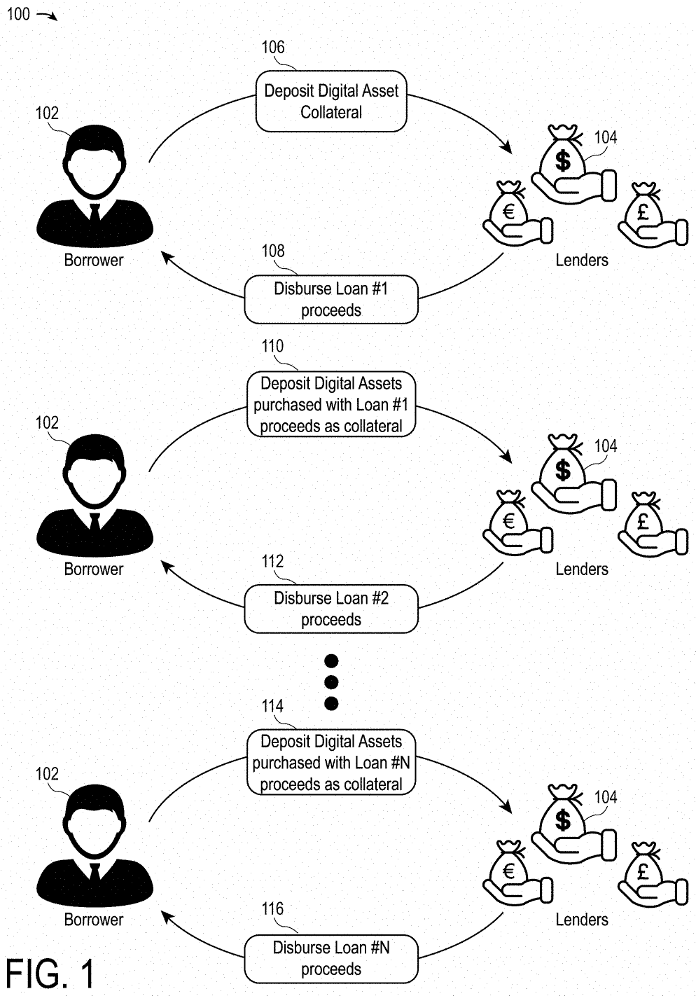

FIG. 1 is an example time series of a borrower 102 and lenders 104 performing a recursive series of digital asset collateralized loans wherein the loan proceeds of each loan in the series is used to collateralize the next loan until a termination point is reached. The first step in the series includes a deposit of digital asset collateral operation 106 according to digital asset collateral loan terms. Since the loans in the time series 100 are collateralized by digital assets, the lenders 104 may decline to assess the creditworthiness of the borrower 102 according to traditional measures (e.g., a credit score, loan history, payment history, etc.), and instead premise the loan solely on availability of the digital asset collateral. In such a scenario, the lenders 104 may offer a minimum initial loan-to-value ratio (LTV) to the borrower 102 such that the borrower must deposit sufficient digital asset collateral funds in operation 106 to satisfy the minimum LTV to originate the loan. The loan terms may further include a cure LTV level, which is the level at which the lenders (and/or a digital asset services provider acting on their behalf) will liquidate the digital asset collateral and extinguish the loan. Commonly, the minimum initial LTV will impact the interest rate offered by the lenders, with a lower initial LTV corresponding to a lower risk loan and thus a lower interest rate.

If the borrower 102 successfully deposits digital asset collateral funds sufficient to satisfy the initial LTV of the loan terms, the lenders 104 respond with a disbursing operation 108 that disburses proceeds of the initial loan (referred to here as Loan #1). In some implementations, the loan proceeds disbursed in operation 108 are fiat currency (e.g., a national currency including without limitation the US Dollar, Euro, Japanese Yen, etc.). In other implementations, the loan proceeds could themselves be a digital asset such as a U.S. Dollar stablecoin (e.g., DAI, Gemini Dollars, USD Coin (USDC), etc.) The borrower 102 is now in possession of loan proceed funds that can be used as desired. At this point, the borrower could choose to use the Loan #1 proceeds to purchase more digital assets (e.g., on the open market at a digital asset exchange). If the borrower 102 elects to do so, then the newly purchased digital assets can themselves be deposited as collateral on the next loan in the series, Loan #2 at operation 110, thus making the process illustrated in FIG. 1 a recursive process.

In one implementation, the lenders are willing to offer the same loan terms or substantially the same loan terms on all the loans in the chain because the decision to originate the loans is based on whether the borrower 102 can supply the digital asset collateral, and not on other factors such as the total debt load, loan to income ratio, or other factors of the borrower that are normally taken into account. As such, the lenders 104 are equally willing to accept the deposit of digital asset collateral in operation 110 as in the initial deposit operation 106. If the minimum LTV is below 1.0, which is likely, then the amount of proceeds received by the borrower 102 from Loan #1 will collateralize a smaller proceeds from Loan #2. A higher minimum initial LTV requirement will result in comparatively more loan proceeds and a lower LTV will result in comparatively less loan proceeds.

When the loan proceeds from Loan #2 are disbursed to the borrower 102 at operation 112, the borrower 112 may repeat the process until a termination point, illustrated here as Loan #N. On each iteration until Loan #N, the loan proceeds of a loan are used to collateralize the next loan. At a certain point, the amount of new loan proceeds available will approach zero and it will no longer be economical to continue the process. Depending on the transaction costs associated with each iteration of the timeseries 100, the economical termination point could be on an iteration significantly before the loan proceeds of the marginal loan actually reach zero or close to zero. If the number of iterations in the timeseries is increased, the additional collateral obtainable converges to a mathematical limit (e.g., an infinite number of iterations). The mathematical limit convergence value is 1/(1−LTV), where LTV refers to the minimum LTV required to originate each loan in the series, assuming all loans are according to the same loan terms regarding LTV. An initial LTV of 0.5, for example, yields a limit convergence value of 2× the initial digital asset collateral as the series approaches infinity iterations.

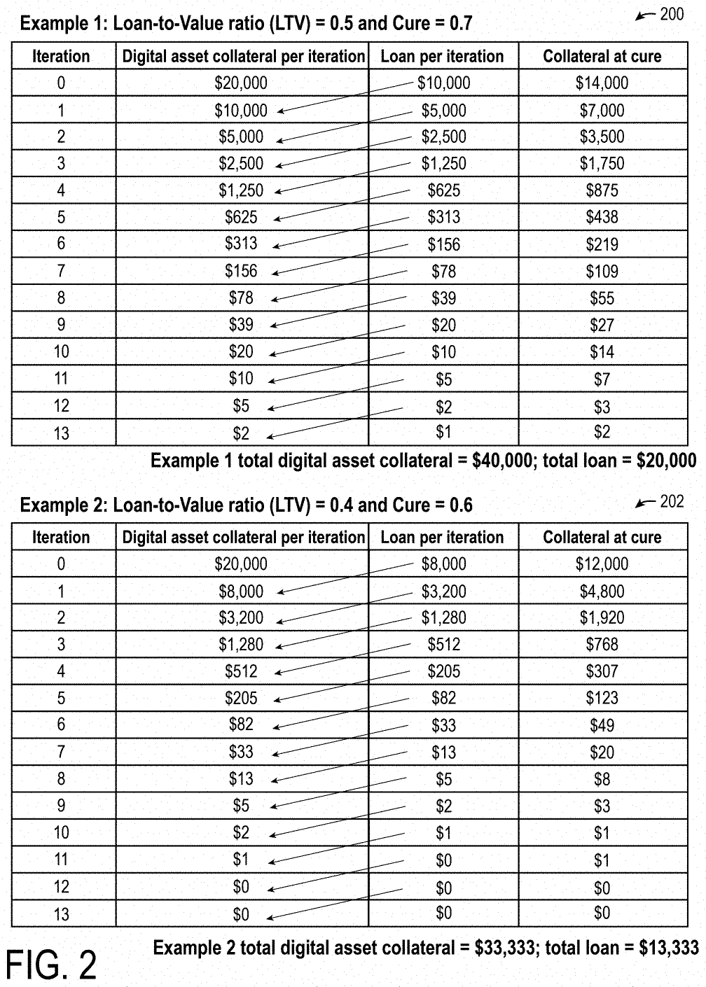

FIG. 2 includes two charts illustrating two examples of iterations on recursive series of digital asset collateralized loans wherein the loan proceeds of each loan collateralize the next loan in the series. In the first example illustrated in chart 200, loan terms are offered to a buyer including an origination LTV of 0.5 and a cure LTV of 0.7. If the buyer starts at iteration 0 with $20,000 USD equivalent of digital assets (e.g., $20,000 worth of a basket of digital assets valued at current available market exchange rates), then iteration 0 yields loan proceeds of $10,000 due to the initiation LTV of 0.5. The $10,000 loan proceeds can now be used at digital asset collateral for iteration 1, yielding loan proceeds of $5,000 according to the initiation LTV of 0.5 loan term.

The last column in chart 200 shows the USD equivalent value of the digital asset collateral if the cure LTV=0.7. The cure LTV is the LTV at which the lender (and/or a digital asset services provider acting on the lender's behalf) will liquidate the digital asset collateral to satisfy the loan. It should be noted that engaging in the loan iterations illustrated in chart 200 does not increase risk of the buyer since the cure LTV is reached at the same underlying price of the digital asset, no matter how many iterations are performed.

As the iterations in chart 200 progress, it is clear that the marginal loan proceeds are approaching zero. The limit as iterations approach infinity is a total of $40,000 digital asset collateral and $20,000 loan. The initiation LTV=0.5 loan term therefore doubles the initial digital asset collateral that the borrower had on iteration 0. As noted above, this relationship can be expressed mathematically as 1/(1−LTV), where LTV is the initiation LTV of each loan in the series.

In contrast to the numerous iterations illustrated in chart 200, a single digital asset collateral loan could be agreed to by the borrower and lender that collapses or consolidates as many recursive iterations as desired into one single set of loan terms (e.g., according to the 1/(1−LTV) factor). In this disclosure, such a single loan representing part or all of a series of recursive loans is referred to as a digital asset multiplier loan or a digital asset collateral multiplier loan.

A second example is shown in chart 202. Here, the loan terms are changed to an initiation LTV of 0.4 and a cure LTV of 0.6. The initiation LTV of chart 202 is more conservative, resulting in ultimately a lower multiplier of the initial digital asset collateral compared to the first example. Under the terms of chart 202, the limit as iterations approach infinity is $33,333 digital asset collateral and $13,333 total loan.

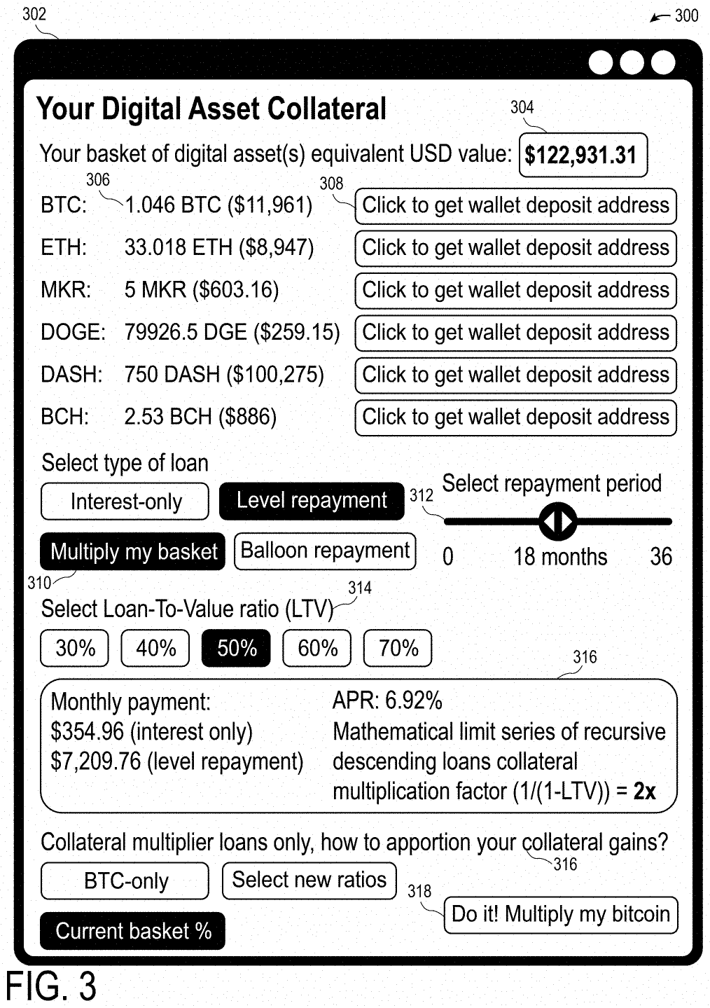

FIG. 3 is a diagram 300 of digital asset multiplication loan parameters 302 and a single-action user interface element 318 for requesting a digital asset multiplier loan equivalent to a recursive mathematical limit series of loans wherein the loan proceeds from each loan collateralize the next loan in the series. The diagram 300 includes a basket of digital assets deposited into a digital asset collateral wallet by the prospective borrower and thus available to be used as collateral on a digital asset loan. The digital asset collateral wallet may be a secure wallet, such as a multisig wallet wherein different parties in the system possess signing keys and a minimum number of the parties would have to sign with their respective keys to spend funds from the wallet. For example, the digital asset collateral wallet may be a 3-of-4 multisig where the borrower, the lender, a digital asset services provider, and an arbiter each hold a signing key. Although the digital asset collateral wallet is referred to herein as a single wallet, it can comprise multiple wallets corresponding to different digital assets on different blockchains. In the example illustrated in FIG. 3, the borrower has deposited amounts of various digital assets including bitcoin (BTC), ether (ETH), MakerDAO (MKR), dogecoin (DGE), Dash (DASH), and bitcoin cash (BCH) as indicated by the relative amounts shown in the digital asset collateral basket 306. For each supported digital asset, a wallet address button 308 provides a payment address unique to the borrower should the borrower wish to add to the basket of digital asset collateral.

Another loan parameter 302 is the type of loan. A borrower may select one or more buttons to choose the repayment terms of the loan (e.g., interest-only, balloon payment, level repayment, collateral multiplier, etc.). Some choices may not be mutually exclusive, for example a loan could be both a “multiply my basket” loan and an “interest-only” loan. Similarly, a repayment period 312 selects a term of the loan (e.g., a term affecting the offered interest rate).

In the example illustrated in FIG. 3, the borrower has selected a “multiply my basket” loan (e.g., a digital asset collateral multiplier loan) with level repayment. One key parameter of this type of loan is the loan-to-value ratio (LTV) required to initiate the loan. An LTV is calculated based on the ratio of the current market value of the basket of digital asset collateral compared to the proceeds of the loan. An LTV selector 314 permits the selection of different initial LTV levels. As the LTV goes lower, the loan may be seen as “safer” by the lender in that there is more safety margin of potential future price decline until the digital asset services provider liquidates the digital asset collateral and uses the proceeds to extinguish the loan. Thus, lenders may be more willing to loan at lower interest rates when the borrower can meet a lower LTV requirement. On the other hand, a higher LTV indicates less security for the lender, thus increasing the risk of the loan.

For the selected collateral multiplier loan parameters, loan terms are computed as shown in box 316. In the example of FIG. 3, an LTV of 50% is selected, corresponding to a doubling or 2× of the initial digital asset collateral according to the formula 1/(1−LTV). If the loan terms in window 316 are acceptable to the borrower, then the borrower may select a single-action user interface element 318 (e.g., a button) to originate the multiplier loan. Selecting the single-action user interface element 318 produces a digital asset multiplier loan that is the equivalent of a series of separate, recursive loans without the cost, overhead, and delay associated with taking out the loans in the series separately. As such, origination and transaction costs are likely to be no more than that of a single loan, but with the benefits to the borrower of some (or all) of the series of recursive loans. The single-action user interface element 318 is thus an improvement over existing technology for multiplying digital asset collateral with a recursive series of loans.

Another element of the loan parameters 302 relates to how to apportion loan proceeds to purchase the multiplied digital asset collateral. In some implementations, borrowers may wish to maintain the digital asset allocation balance of the initial digital asset collateral basket 306 when acquiring the new digital asset collateral. In other words, whatever balance among digital assets is present in the initial basket will be replicated in the additional digital assets. Other allocations of digital asset collateral multiplier gains are also possible. For example, a borrower could choose for all additional digital asset collateral to be a single type of coin (e.g., bitcoin), or, in other implementations, the borrower could select a custom ratio set among the same or different digital assets as what is in the basket of digital asset collateral. In computing the LTV of a digital asset multiplier loan, the apportionment shares among various assets is not important, but rather the current aggregate market value of the whole basket of digital asset collateral can be relied upon.

Although the digital asset collateral multiplier loan may appear to be increasing leverage or increasing risk to the borrower, such a loan actually is not more likely to be liquidated than a conventional digital asset collateral loan wherein the user does not perform the recursive series. The reason is that, if the collateral multiplier loan and the traditional collateral loan have the same LTV requirement, both types of loan will be liquidated at the same market price of the collateral asset. In other words, a decline in the market value of the collateral asset triggers either type of loan at the same time, and thus one is not liquidated sooner than the other (e.g., neither loan is “riskier” than the other with respect to the market value of the digital asset collateral). The collateral multiplier loan can thus be viewed as merely an efficient and convenient method to allocate loan proceeds if the borrower wishes to maximize price exposure to the underlying collateral asset to an extent (e.g., the mathematical limit convergence value) that would not be possible with a series of discrete digital asset collateral loans.

Accepting deposit of the digital assets into the digital asset collateral basket 306 is not merely the reorganization or tracking of data. In the case of a digital asset, the spending key is itself money. If proper private key hygiene procedures are followed, then the private spending key (at least in the case of a single sig encumbrance on the funds) is the only copy of the key possessed by anyone, anywhere in the world. The owner of the key may also possess a backup, such as a recovery seed set of works (e.g., according to the BIP39 bitcoin improvement proposal) that can deterministically generate the spending keys of a wallet, but then the recovery seed can be thought of as the wallet itself. Whether possession is of the keys themselves or the means to deterministically generate the keys does not matter. In either case, taking deposit of the basket of digital asset collateral 306 is conceptually similar to taking physical possession of a precious metal. There is no one in a position to reverse a mistaken action or recover funds if lost. The deposit of the digital asset funds into the basket 306 is therefore more similar to taking delivery of a good or precious metals that must be guarded and protected against loss. It is a notion of physical custody of the keys.

Taking possession of the digital assets in the basket of digital asset collateral funds 306 is not conceptually changed in the case that the basket 306 is a multisig wallet. If the collateral digital asset funds are stored in a multisig wallet, there is still the notion of physical custody of the deposited funds, the only difference being that no one party can unilaterally spend or move the funds. An analogy may be a safe with three separate locks with keys held by distinct and separate entities or persons that can only be opened if a sufficient subset of the keys have been turned.

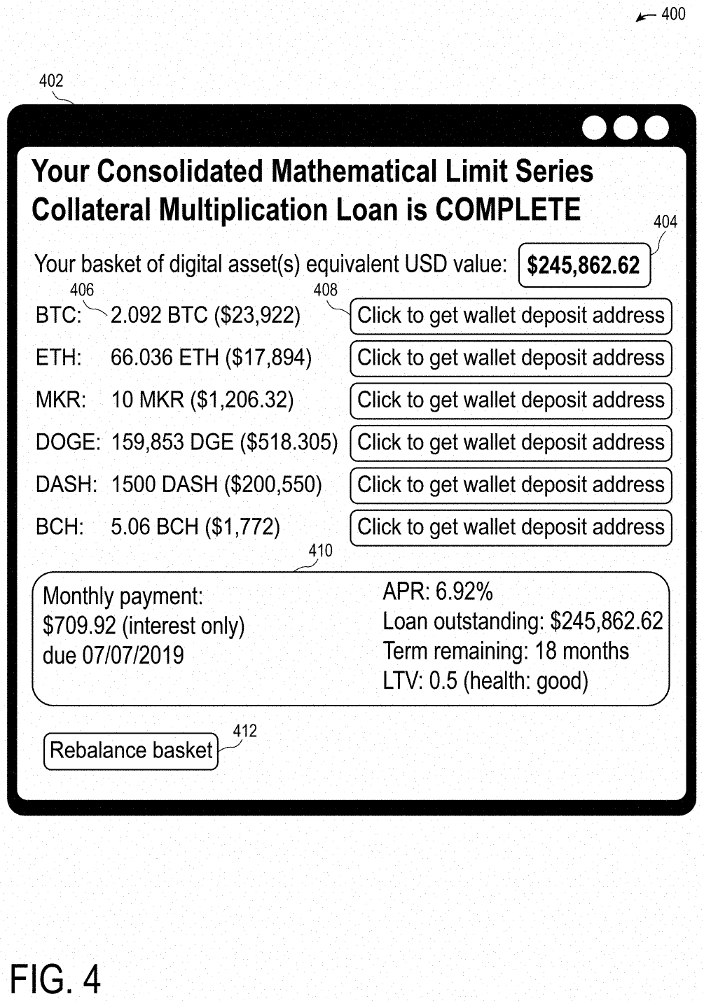

FIG. 4 is a diagram 400 of digital asset collateralized multiplier loan health status parameters 410 and digital asset collateral wallet interface 402. The digital asset collateralized multiplier loan health status parameters 410 show the status of the multiplier loan after the borrower has selected, via a single-action user interface element, the digital asset multiplier loan, and the digital asset services provider has acquired the additional multiplier digital asset collateral and credited the multiplier digital assets to the borrower's account. In the example illustrated in FIG. 4, the additional digital asset collateral is double the initial digital asset collateral due to the 0.5 LTV loan term. The basket of digital asset collateral 406 is double the amount shown in FIG. 3 for each asset in the basket because the borrower has elected to copy the relative composition of the digital asset collateral basket in acquiring the multiplier collateral. Wallet deposit buttons 408 allow the borrower to request a deposit address for a given digital asset in the basket if the borrower wishes to add to the digital asset collateral during the course of repayment of the loan, which the borrower may elect to do if the LTV health of the loan is not good and thus in danger of liquidation.

A loan health status window 410 displays statistics regarding the health of the digital asset multiplier loan including monthly payment, current interest rate, outstanding principal, term remaining, and current LTV. If the LTV rises, a warning level may be reached at which point the borrower is alerted to the degraded loan health and given an opportunity to bolster the digital asset collateral basket with a deposit of new digital asset collateral.

The borrower may choose to rebalance the digital asset collateral basket with rebalance basket button 412. As noted herein, the composition of the types of digital assets in the basket may be disregarded and only the aggregate current market value is used to compute loan health. In other implementations, the various types of digital assets in the basket are given weighted values to reflect the ease with which the digital assets could be converted into fiat currency. For example, some digital assets with lower relative available liquidity may be harder to sell and a large sell order may be more likely to move a market price, thus netting less than what appears to be the market value in a liquidation scenario. Other types of digital assets (e.g., bitcoin) may have much larger overall liquidity and more potential counterparties, thus weighting the digital asset more compared to the others in the basket.

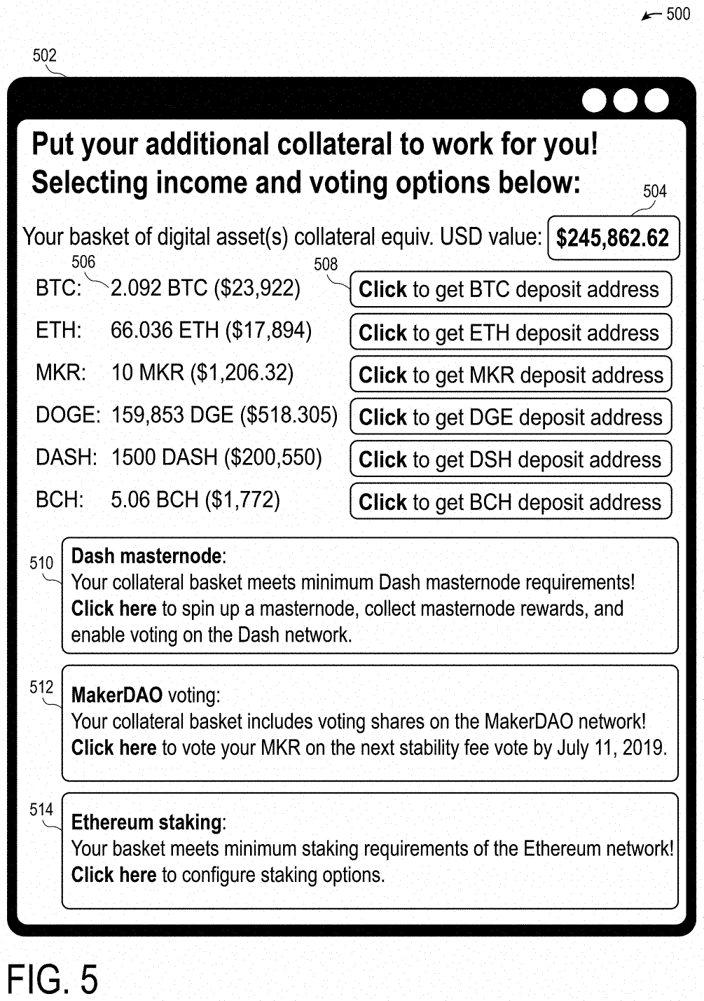

FIG. 5 is a diagram 500 of a digital asset rights management and exercise platform 502 for digital assets held on behalf of a borrower in a digital asset collateral wallet. Digital assets are sometimes associated with rights other than simply the right to transfer ownership of the digital asset by sending a transaction to a payment address. The term “digital rights” as used herein means the right to a benefit accruing to the owner of the digital asset. Usually the exercise of a digital asset right involves signing a blockchain transaction with private keys associated with the digital asset. If the digital assets are legally owned by the borrower but held in a digital asset collateral wallet by a digital asset services provider as collateral for a loan, the borrower may not unilaterally control private keys necessary to exercise the digital rights associated with the digital asset. Since the borrower is nonetheless the legal owner of the digital assets, the digital asset services provider may accept digital rights instructions from the borrower and carry out the instructions by utilizing the digital assets in the digital asset collateral wallet accordingly with any benefits incident thereto accruing to the borrower.

The digital rights management and exercise platform may be operated by a digital asset services provider managing digital asset collateral for a loan. The platform 502 shows a basket of digital assets associated with the borrower (e.g., owned by the borrower but held in a digital asset collateral wallet not subject to unilateral control by the borrower). The basket has a market value 504 and contents of the basket 506. The platform 502 allows for requesting a payment address for the borrower to add to the basket with buttons 508.

One type of digital rights is the right to operate a masternode. A masternode is a special type of node on a network that performs the typical duties of a node (validating transactions, propagating transactions in a memory pool, verifying new blocks, trading blocks with other members of the peer-to-peer blockchain network, mining activity to secure the network, etc.) but also may have special privileges and responsibilities. For example, a masternode may be entitled to remuneration for carrying out the node duties collect a fraction of the fees earned by a network or entitled to a fraction of new coins minted by a network. In other examples, a masternode may be entitled to vote its assets on proposed changes to the consensus rules of the blockchain on which it trades.

In the example illustrated in FIG. 5, the basket of digital asset collateral includes the Dash digital asset. As Dash is a network including masternodes, the platform 502 may provide a digital rights instruction window 510 offering Dash masternode services. On the Dash network, there is a minimum amount of the Dash digital asset needed to participate on the network as a masternode. Not all holders of the digital asset can therefore engage in masternode activities unless the holder meets the threshold value requirement. In the case of Dash, a masternode must hold at least 1,000 Dash to qualify as a masternode consensus rules that are current but subject to change.

The digital rights instruction window 510 includes a link for the borrower to request spinning up a masternode using the Dash collateral held in the digital asset collateral wallet. The digital asset services provider operating the platform 502 may offer to handle provision of computing resources (e.g., processor, data storage, bandwidth resources, etc.) needed to operate the masternode in return for a fee. The borrower would be entitled to collect the economic rewards of the masternode and engage in any governance of the Dash network that are included in masternode privileges. If the digital asset service provider controls the digital asset collateral wallet, the digital asset services provider may move the Dash digital assets to a wallet associated with the masternode, while still preserving the ability to liquidate the Dash digital assets if needed to extinguish the collateralized loan (e.g., if the LTV health of the loan drops below a liquidation threshold).

In the example illustrated in FIG. 5, the borrower did not have enough Dash to operate a masternode until the digital asset collateral was increased 2x due to the multiplier loan. Without the multiplier loan, the borrower would have been locked out of Dash masternode participation. Digital asset multiplier loans therefore open access to digital asset rights that would not have been available to the borrowers without the loan. The borrower would not have been able to collect Dash network fees and income available to masternode operators.

Another type of digital rights are voting rights. Some digital assets may be described as “governance coins” in that holders of the coins may “vote” the coins with respect to proposals regarding the governance of a network or service associated with the coin (e.g., upgrades to the Ox network). A participant wishing to influence the outcome of a vote is limited by how much of the voting digital asset is controlled by the participant. This system may be designed to vest more voting power in participants who are more heavily financially invested in the digital asset. If a borrower is using a digital asset with voting rights as collateral, the borrower can magnify his influence on the votes by entering into a digital asset multiplier loan to increase the amount of voting digital assets under control.

In the example illustrated in FIG. 5, a digital rights window 512 explains that the basket of digital assets includes the MakerDAO (MKR) digital asset. MakerDAO is a decentralized autonomous organization with smart contracts on the ethereum network that implement the DAI stablecoin via collateralized debt positions (CDP). The DAI stablecoin is overcollateralized by an underlying digital asset or basket of digital assets, which can be liquidated if the DAI fails to maintain a peg to the US Dollar. Over time, changes in the economic incentives of the MakerDAO system can cause supply imbalance of the DAI stablecoin. To address these issues, the MKR tokens have voting rights to continually adjust key economic parameters to maintain stability. MKR token holders are incentivized to expend resources administering the MakerDAO system because certain system events that occur when the system is operating as intended burn MKR tokens, thus increasing scarcity and potentially value of MKR.

The MKR votes may be regularly scheduled votes regarding the parameters of the system. For example, a “stability fee” is charged for minting fresh DAI. The stability fee may be frequently changed based on the outcome of the votes. If a MKR holder participant wished to increase his influence over the outcome of MKR votes, the MKR holder could become a borrower in a digital asset multiplier loan wherein the additional digital asset collateral of the loan is used to purchase more MKR tokens. When MKR votes occur, the borrower could issue digital asset digital rights instructions to the digital asset services provider administering the platform 502 to vote the MKR tokens, including the additional MKR tokens acquired as part of the loan, in the manner desired by the borrower. The borrower thus can increase influence over the votes without increasing leverage (e.g., a digital asset multiplier loan is not a risk increase compared to a non-multiplier loan for a given LTV cure level).

Another type of digital asset digital rights are staking rights. In any distributed consensus system, there is a way for the participants to decide which validator should add the next block in the chain. In proof-of-work based networks, such as bitcoin, the validators are referred to a miners who expend resources continually guessing a cryptographic nonce value such that the header of a draft block (e.g., a potential next block in the chain) meets a difficulty target. The mining process is by design resource intensive to provide scarcity of new money supply. Any mining participants are therefore required to acquire or control expensive mining hardware to perform the mining calculations.

Staking is an alternative consensus mechanism to proof-of-work in which the validators are required to “stake” (e.g., to lock up) an amount of the digital assets associated with the validator's application of the consensus rules of the blockchain. If a validator applies the consensus rules in accordance with the majority of the network, then the new supply of digital assets will flow to the honest validator (e.g., the staking reward). On the other hand, if the validator applies consensus rules that are not in accordance with the majority of the network, then the staked coins will be burned, causing harm to the dishonest staker. It is therefore a feature of the design that an incentive should exist to apply the consensus rules in accordance with the majority because the staked funds will otherwise be lost.

In compensation for accepting the risks of staking, new supply of the digital assets may be rewarded to the stakers. If the basket of digital asset collateral 506 includes a staking coin, then the right to stake it may be considered a digital right. In digital right instructions window 514, an option exists to stake on the ethereum network to earn the staking reward. Similar to a masternode, there may be a minimum amount of the digital asset required to stake. Any user possessing less than the staking minimum will not be able to participate in the network as a staker.

In the case of a digital asset multiplier loan, however, a borrower who has at least half the required amount to stake (assuming an initial loan LTV of 0.5) can increase the amount of the asset to a level sufficient to participate in staking. The digital asset services provider operators of the platform 502 may thus offer staking digital right exercise to the borrower. The rewards for such as staking arrangement may be split between the digital asset services provider according to an agreement between the two. The digital asset services provider would likely be required to supply resources such as computing, data, and bandwidth resources to perform the staking for which a fee could be collected.

In implementations described herein, the digital asset collateral, including the multiplier digital asset collateral, are described as being held in a digital asset collateral wallet that may not be spendable unilaterally by the borrower. In the case of digital rights exercise, the digital asset collateral may be held in other ways, depending on the type of digital asset rights to be exercised. One example is the masternode. The masternode itself may be similar to any blockchain network full node in that the node participates in a message sharing scheme with the other network nodes (e.g., a gossip communications protocol) to share pending transactions and updates to the ledger. Unlike other types of network nodes, a masternode is only authorized to participate as such if the masternode is associated with control of a minimum amount of funds. Thus, the operation of the masternode and the authorization to do so are separate conceptually. In some implementations, a digital asset services provider may both control the digital asset collateral funds and operate the masternode.

In other implementations, the borrower herself may operate the masternode. If the borrower operates the masternode, then the transaction associating the multiplier digital asset collateral funds therewith may require participation from the digital asset services provider, the lender, and/or other participants in the system (e.g., in an n-of-m multisig scenario). Thus, if the borrower wishes to initialize the masternode or perform other functions such as voting on consensus rules of the network with the digital asset multiplier funds, then the parties will have to cooperate to allow the borrower to do so (e.g., by signing an authorization transaction with their respective portions of the required quorum of the multisig spending keys).

By use of the term “digital rights” granted based on the control of digital assets due to possession of a signing key, it is not meant in the same way as digital rights in other areas such as royalty rights on media content, the right to playback a copyrighted movie on a device over a period of time or forever, rights associated with downloading gaming content (e.g., DLC) that entitled the purchaser to a digital download and potentially updates or upgrades over time. Digital rights based on ownership of a digital asset are different. The rights may be exercised by signing a transaction valid on a network of a blockchain or signing a message used by the network (e.g., as input to a smart contract executing on the blockchain) to prove ownership and control of the associated digital asset. For example, the owner of an unspent transaction output on the bitcoin network could prove ownership and spendability of the funds by signing a message with the spending key. The resulting output could be confirmed by network observers by confirming that the signed message is decrypted using the public key associated with the funds (e.g., the signer's payment address).

In much the same way, voting may be tied to the control of digital assets. A voting system wherein rules on a platform or protocol are editable by the community could choose to assign one vote to a unit of the digital asset (e.g., the Ox Protocol on the ethereum network, decentralized corporations organized by Aragon smart contracts on ethereum, changes to the consensus rules on the Dash network, adjustment of key economic parameters on decentralized finance applications such as MakerDAO, Dharma Protocol, etc.). Under these systems, possession of more of the associated assets grants the ability to have more control or to engage in more participation than would be possible with possession of less of the digital asset. If the digital asset in question has a market value, then obtaining an amount of the asset sufficient to attack and disrupt the operation of the network is costly, thus providing defense against attackers and a stake in a positive operation and outcome of the network since the decision makers are owners of various amounts of the digital asset. In this way, the digital asset collateral mathematical limit recursive loan unlocks utility and value that would not be possible under conventional business arrangements.

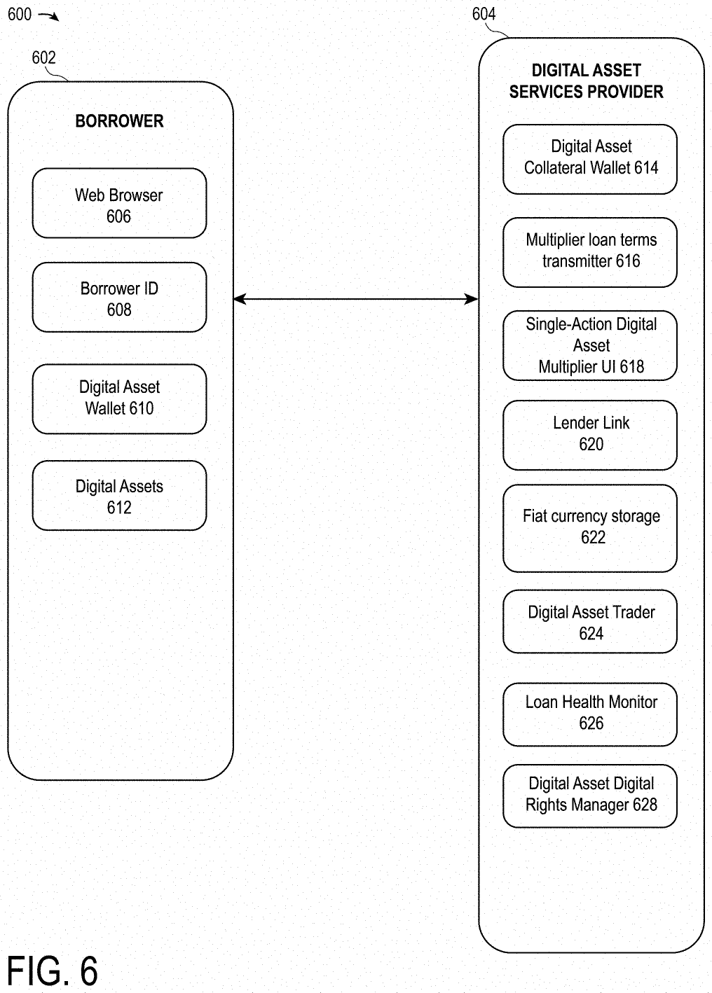

FIG. 6 is a block diagram of a relationship 600 between a borrower client 602 and digital asset services provider 604 in an example system for single-action digital asset loan collateral multiplication. In the example illustrated in FIG. 6, the client 602 may be a potential borrower in a digital asset multiplication loan. The client includes a web browser 606 for interacting with the digital asset services provider 604, such as for communications relating to the parameters of a digital asset backed loan and/or digital asset multiplication loan (e.g., loan term, initial LTV, cure LTV, digital asset collateral type(s), etc.) and for receipt and agreement to initial loan terms and/or digital asset multiplication loan terms.

A borrower ID 608 can be used to link a particular borrower with a deposit address so that a deposit of digital asset collateral can be associated with the correct borrower. In implementations, the borrower ID 608 may be an address of the digital asset wallet 610. The digital asset wallet 610 can be incorporated into the web browser 606 (e.g., as a browser extension) or can be a separate wallet (e.g., a mobile wallet, a hardware wallet, a node wallet, etc.). The digital asset wallet 610 could also be a custodial wallet controlled by the borrower, such as funds on deposit at a digital asset exchange and disbursable by the borrower from the exchange's hot wallet. The digital asset wallet 610 may actually be a collection of wallets, each wallet being associated with a different digital asset.

Another component of the borrower 602 are the digital assets 612 themselves. Since the lender likely will not originate funds until digital assets satisfying the initial LTV are deposited, the loans described herein are not possible without an initial digital asset or basket of digital assets 612 controlled by the borrower.

The other side of FIG. 6 illustrates the components of the digital asset services provider 604. One component of the digital asset services provider 604 is the digital asset collateral wallet 614. Depending on the configuration of the digital asset services provider 604, the digital asset collateral wallet may be a wallet unilaterally controlled by the digital asset services provider 604. In other implementations, the digital asset collateral wallet 614 is an n-of-m multisig wallet wherein various participants in the system described herein (e.g., lender, borrower, digital asset services provider, arbiter, etc.) each have a key and a subset must cooperate to spend funds or sign messages from the digital asset collateral wallet 614. The multiplier loan terms transmitter 616 may be a web server or other communications apparatus to determine and communicate available lending terms (e.g., loan term, LTV requirements, fees, etc.) to the borrower 602 (e.g., via the web browser 606). In some implementations, the multiplier loan terms transmitter 616 includes user interface elements (e.g., a slider) to assist the borrower 602 determine how changes in the loan parameters affect available loan terms (e.g., a higher initial LTV increases the interest rate offered to the borrower 602).

A single-action digital asset multiplier UI 618 allows the borrower 602 to obtain a digital asset multiplier loan with terms equivalent to a series on recursive digital asset collateralized loans wherein the proceeds of each loan in the series collateralize the next loan in the series. The single-action digital asset multiplier UI 618 may form a loan request based on the loan parameters received from the borrower 602 in connection with the digital assets 612 deposited by the borrower 602 into the digital asset collateral wallet 614. In contrast to obtaining digital asset collateral multiplication by engaging in a series of separate recursive loans, the single-action digital asset multiplier UI element 618 provides the borrower 602 with an opportunity to minimize costs associated with the digital asset collateral multiplication and to reap the full potential benefit of recursive loans (e.g., to the mathematical limit convergence value) in a single step.

One component of the digital asset services provider 604 is the lender link 620. Depending on how the single-action multiplier loan is configured, it may be necessary to advance the loan proceeds on behalf of the buyer before the digital asset collateral has been acquired. This is unlike an initial digital asset collateralized loan where the lenders may choose to wait to disburse loan proceeds until after the digital asset collateral is deposited. In a single digital asset multiplier loan, on the other hand, the various iterations are not separately performed, thus the mechanic of using loan proceeds to acquire more digital asset collateral for the next loan in the series is not available.

The lender link 620 can address this problem in several ways. In one implementation, the lender link 620 can advance the multiplier digital asset collateral on behalf of the borrower such that lenders still only disburse loan proceeds after the full digital asset collateral is in possession. In the example of an LTV of 0.5 where the multiplier loan doubles the borrower's initial digital asset collateral, the lender link 620 may supply the second half of the doubled collateral, then receive reimbursement from a lender in the form of the loan proceeds when the loan is disbursed. In other implementations, the lender link 620 is a relationship with the lender wherein the lender link 620 “vouches” for the loan terms and the deposit of the initial digital asset collateral such that the lender chooses to disburse the loan proceeds before the multiplier digital asset collateral has been acquired.

Another component of the digital asset services provider 604 is the fiat currency storage 622. In implementations, the fiat currency storage 622 may be a legacy banking system account (e.g., a business checking account) for holding fiat currency such as US Dollars. In other implementations, the fiat currency storage 622 may be a digital asset wallet holding a fiat-currency pegged stablecoin.

Whatever the form of the fiat currency storage 622, the digital asset services provider 604 may draw upon the funds therein if it is necessary to advance or “front” the funds needed to acquire the multiplier digital asset collateral if a lender is not willing to disburse loan proceeds until digital asset collateral has been acquired. Once the digital asset collateral has been acquired and the loan proceeds are disbursed, the digital asset service provider 604 may be reimbursed by sending the loan proceeds to the fiat currency storage 622. In implementations wherein the lender is willing to disburse loan proceeds before the digital asset collateral has been acquired, then the digital asset services provider 604 may receive the proceeds to the fiat currency storage 622 from which to draw to acquire the multiplier digital asset collateral.

Another component of the digital asset services provider is the digital asset trader 624. The digital asset trader 624 may have access to several sources of funds, including the fiat currency storage 622 and the digital asset collateral wallet 614, and access to marketplaces where digital assets may be traded. The digital asset trader 624 can thus carry out several functions of the system. One function handled by the trader is the valuation of the basket of digital asset collateral deposited by the borrower in the digital asset collateral wallet 614. As the basket may have several types of digital assets, it may not be possible to obtain market values from a single exchange or marketplace because there may not be a single exchange that supports trading on all types of digital asset collateral in the basket. Instead, the digital asset trader 624 may make connections with multiple exchanges, over-the-counter desks, marketplaces, brokers to ascertain a market value for a given digital asset.

The digital asset trader 624 is responsible for acquiring digital assets from the market when called upon to create the digital asset multiplier loan. Whether the purchase funds are advanced by the digital asset services provider 604 or advanced by the lender, the digital asset trader 624 must convert those funds into the multiplier digital assets and deposit the multiplier digital assets into the digital asset collateral wallet 614. For example, if the initial LTV is 0.5 and the initial deposit of digital asset collateral is $20,000 USD equivalent in bitcoin, then the initial loan proceeds are $10,000. If the initial loan proceeds are held by the digital asset services provider 604, then the trader may use these funds to acquire half of the doubling of the digital asset collateral such that only $10,000 must be advanced by the digital asset services provider 604 and/or the lender. If the loan health monitor 626 triggers a liquidation condition (e.g., a cure LTV has been reached on the digital asset multiplier loan), then the digital asset trader 624 must convert some or all of the funds in the digital asset collateral wallet 614 back into fiat funds.

One function of the digital asset trader 624 is to monitor liquidity conditions on the digital asset marketplaces. A market exchange rate based on, for example, the last completed trade on an exchange may cause an illusion that the digital asset services provider 604 could obtain the same price if it also chose to sell the same digital asset. If liquidity is low, however, placing a large buy or sell order could move the market price significantly. The digital asset trader 624 thus can reject a multiplier loan request if it is not possible to acquire the multiplier assets without causing significant price movement. Similarly, if liquidity conditions suggest liquidating digital asset collateral is becoming more problematic, then the digital asset trader 624 can alter LTV alert and cure parameters.

A loan health monitor 626 is a component of the digital asset services provider 604 that receives market data from the digital asset trader 624 to determine a health score of a digital asset multiplier loan. One way to calculate the health score is based on a current LTV of the digital asset multiplier loan. In examples herein, a digital asset multiplier loan has an initial LTV of 0.5 and a cure LTV of 0.7. In other words, a borrower must supply an amount of digital asset collateral that is double the amount the borrower wishes to receive in loan proceeds. If the market value of the basket of digital asset collateral declines with respect to the principal of the loan beyond a ratio of 0.7, then the loan health monitor can order a liquidation of the digital asset collateral wallet 614 from the digital asset trader 624. Before a cure LTV has been reached, the loan health monitor 626 may send one or more alerts to the borrower warning of impending liquidation and inviting the borrower to add more digital assets to the digital asset collateral wallet 614 and/or pay down the digital asset multiplier loan principal until the LTV improves to a safer level.

The digital asset services provider 604 also includes a digital asset digital rights manager 628. The digital asset rights manager 628 itself may include subcomponents directed to different types of digital rights exercise. For example, digital rights involving participation in a blockchain network (e.g., as a node on the network) require computing resources such as CPU, data storage, RAM, internet bandwidth, etc. and consume power, physical space, maintenance, and other resources. The digital asset rights manager 628 may provide these resources on behalf of the borrower and in connection with signing provided by the digital asset collateral wallet 614 (e.g., signing messages proving ownership of the digital assets in the collateral wallet 614, signing transactions locking digital assets into a contract, signing voting transactions, etc.).

Other subcomponents of the digital asset digital rights manager 628 may include a voting rights portal. The voting rights portal may perform tasks including notify the borrower of voting opportunities for digital assets in the borrower's basket of digital asset collateral, presenting voting options to the borrower, collecting the borrower's voting preferences, and signing transactions on a network of a blockchain causing the borrower's votes to be counted. Similarly, the digital asset digital rights manager 628 may notify the borrower of staking opportunities, collect staking instructions from the borrower (e.g., how much to stake, how to deploy staking rewards, etc.), and process staking rewards (e.g., add staking rewards to the digital asset collateral basket, convert to fiat funds and distribute to the borrower, credit the staking rewards towards the borrower's principal and interest payments due on the digital asset multiplier loan, etc.).

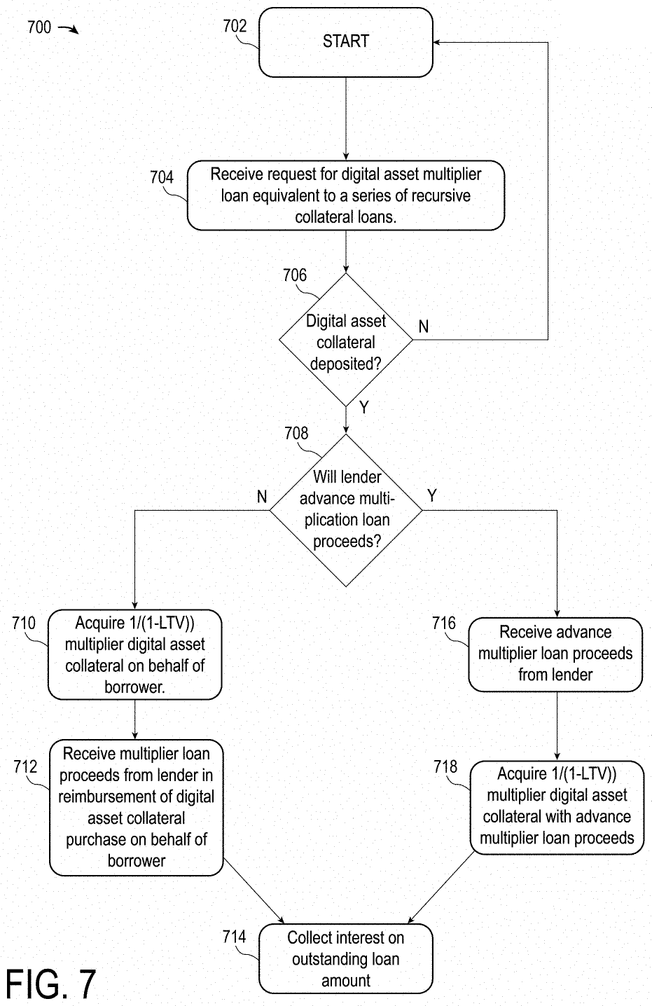

FIG. 7 is an example workflow 700 of a digital asset services provider offering single-action digital asset multiplication loans collateralized by digital assets. After a start block 702, the workflow includes a receiving operation 704 that receives a request for a digital asset multiplier loan equivalent to a series of recursive digital asset collateral loans wherein the proceeds of each loan collateralize the next loan in the series. It is not necessary that the limit series is an infinite series (e.g., the convergence value of an infinite series). The series could also be a finite series wherein the parameters are something less than the infinite limit. The receiving operation 704 may include presenting adjustable loan parameters to a potential borrower that produce a set of proposed loan terms, depending on the loan parameters chosen by the potential borrower. The receiving operation 704 is the result of a single-action request on the part of the potential borrower (e.g., clicking a “double my bitcoin” button). As such, there is no need for the borrower to request more than one loan in the series of recursive loans. Instead, the digital asset multiplier loan is a single equivalent financial structure to the recursive series of loans, without the cost and overhead of completing multiple loans.

A decision block 706 determines whether sufficient digital asset collateral has been deposited by the borrower. In the series of discrete recursive loans, the initial digital asset collateral deposit can be viewed as the seed that starts the recursive chain, which runs until the termination point. Since the digital asset collateral multiplier loan is a loan that is mathematically equivalent to some number of recursions, it also begins with a digital asset collateral deposit by the borrower.

The next decision block 708 is needed due to a difference between the way the chain of discrete recursive loans works compared to the single digital asset collateral multiplier loan. With the chain of discrete recursive loans, the proceeds from each loan in the chain collateralize the next loan. In the digital asset collateral multiplier loan, on the other hand, the descending loan proceeds are not available in the same way because it is a single loan. There is therefore somewhat of a chicken-an-egg problem wherein loan proceeds intended to be used to acquire additional digital asset collateral are not available until the loan closes, which requires the full amount of digital asset collateral.

There are disclosed herein two ways to address the aforementioned problem. Which of the two ways depends on whether a lender is willing to advance loan proceeds at decision block 708 before the additional digital asset collateral has been acquired. In the series of discrete recursive loans, the lender need not advance loan proceeds because loan proceeds need only be disbursed after sufficient digital asset collateral from the borrower has been secured in the digital asset collateral wallet. With a digital asset collateral multiplier loan, on the other hand, only the initial digital asset collateral is on hand and the additional digital asset collateral has yet to be acquired.

If the lender does advance the loan proceeds, workflow 700 advances to operation 716, wherein the digital asset services provider receives the advance proceeds from the lender. In implementations, the digital asset services provider and the lender have an agreement that the advance loan proceeds will only be used to acquire the additional digital asset collateral for the digital asset multiplier loan. The lender may have a higher degree of trust and an ongoing business relationship with the digital asset services provider, unlike the lender's relationship with the borrower. If the lender trusts the digital asset services provider to use the advance loan proceeds as agreed, then the lender may decide to advance the funds if the digital asset services provider approves a digital asset multiplier loan with the borrower. The workflow 700 then proceeds to operation 718, wherein the digital asset services provider acquires digital asset collateral with the advance loan proceeds. In implementations, the amount of additional digital asset collateral acquired is substantially 1/(1−LTV) times the initial digital asset collateral, where LTV is the initial LTV term offered by the lender.

If a lender does not want to advance the loan proceeds at decision block 708, then the workflow 700 proceeds to acquisition operation 710. In acquisition operation 710, some other participant (e.g., the digital asset services provider) must advance funds to perform the acquisition. After the acquisition operation 710 is complete, the digital asset services provider can prove to the lender that the additional digital asset collateral has been purchased and thus would be available for liquidation should the LTV health of the loan enter liquidation territory. With the collateral provably secure, the lender can then decide to disburse the multiplier loan proceeds, which are received by the digital asset services provider at operation 712. The funds received at operation 712 can reimburse the digital asset services provider, or whichever participant advanced the funds used to acquire the additional digital asset collateral.

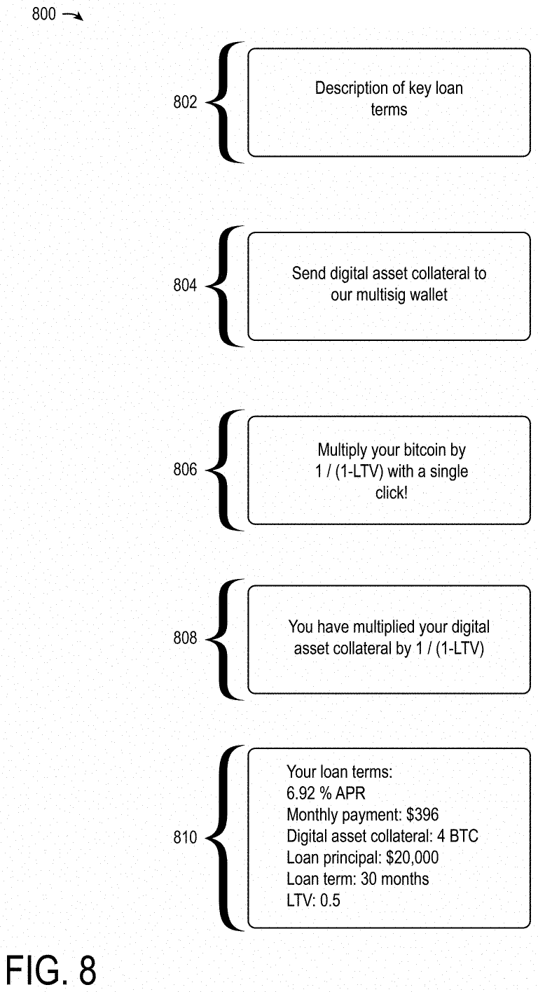

FIG. 8 is an example workflow 800 of user interface elements and actions associated therewith presented to a borrower regarding digital asset collateral multiplication loan from the perspective of the borrower. An element 802 displays key loan terms to the borrower. The element 802 may include a variety of loan parameters the borrower can adjust to determine what impact the adjustment has on loan terms offered by the lender. Loan parameters include without limitation loan term, type(s) of digital asset collateral for the basket, initial LTV, cure LTV, interest rate, and type and apportionment of the additional digital asset collateral (e.g., all bitcoin, same percentage mix as the digital asset collateral basket, a custom apportionment, etc.).

When the borrower finds loan terms that are acceptable, element 804 sends digital asset collateral to the digital asset collateral wallet. This wallet may be a multisig wallet controlled by a combination of participants in the system. In other implementations, the wallet can be unilaterally controlled by a non-borrower participant such as the digital asset services provider, the lender, etc. The element 804 may include presentation of a payment address to the borrower such as an alphanumeric public cryptographic key (or a value derived therefrom), a QR symbolic barcode for scanning, etc.

An element 806 is the single-action digital asset collateral multiplier loan request user interface element. In an implementation, the element 806 is a single button the borrower can click after acceptable loan terms are determined and sufficient digital asset collateral has been deposited to the collateral wallet. In a sense, any amount of digital asset collateral could be considered sufficient since the digital asset multiplier loan simply multiplies (e.g., by 1/(1−LTV)) whatever digital asset collateral the borrower has. The element 806 is distinct from the process of closing a series of recursive digital asset collateral loans since there is only a single step and a non-borrower party will advance the funds needed to offer a loan equivalent to a series of recursive loans.

Since the loan proceeds are used to acquire additional digital collateral, there is not necessarily any funds for the borrower to withdraw. Accordingly, the workflow 800 informs the borrower of the acquisition of the additional digital asset collateral at element 808. At least initially, it is likely there will be no funds for the borrower to withdraw, however if the market value of the basket of digital asset collateral appreciates over time, then the terms of the loan can allow partial liquidation as long as the market value of the basket of digital asset collateral still satisfies loan LTV requirements after the partial liquidation. In some implementations, the element 808 includes one or more blockchain addresses of the digital assets in the basket of digital asset collateral. The borrower can thus view the funds on a public shared ledger, thus trustlessly verifying the funds do, in fact, exist, and the digital asset services provider has not used the loan proceeds funds for a purpose other than acquiring the borrower's additional digital asset collateral for the multiplier loan. Element 810 is a display to the borrower of a current loan state and LTV health.

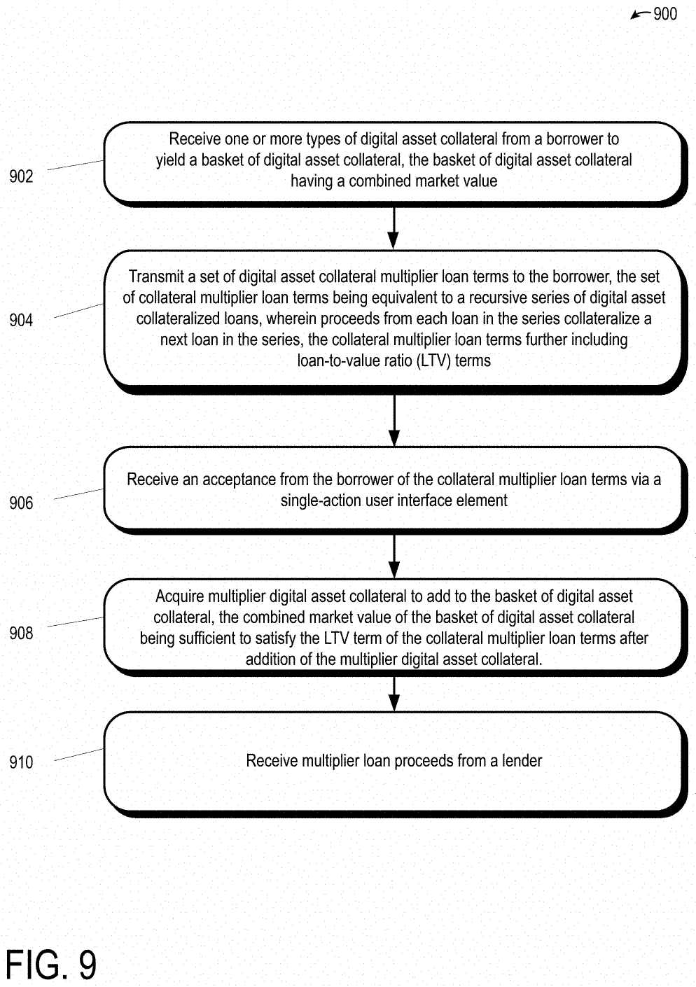

FIG. 9 is an example workflow 900 of a method for automatically collapsing a recursive series of digital asset collateral loans into a single digital asset collateral multiplying loan. A receiving operation 902 receives one or more types of digital asset collateral from a borrower to yield a basket of digital asset collateral, the basket of digital asset collateral having a combined market value. A transmitting operation 904 transmits a set of digital asset collateral multiplier loan terms to the borrower, the set of collateral multiplier loan terms being equivalent to a recursive series of digital asset collateralized loans, wherein proceeds from each loan in the series collateralize a next loan in the series, the collateral multiplier loan terms further including loan-to-value ratio (LTV) terms.

A receiving operation 906 receives an acceptance from the borrower of the collateral multiplier loan terms via a single-action user interface element. An acquiring operation 908 acquires multiplier digital asset collateral to add to the basket of digital asset collateral, the combined market value of the basked of digital asset collateral being sufficient to satisfy the LTV term of the collateral multiplier loan terms after addition of the multiplier digital asset collateral. Another receiving operation 910 receives multiplier loan proceeds from a lender. A purchasing operation 912 acquires additional digital asset collateral on behalf of the borrower to collateralize the multiplier loan to satisfy the multiplier LTV.

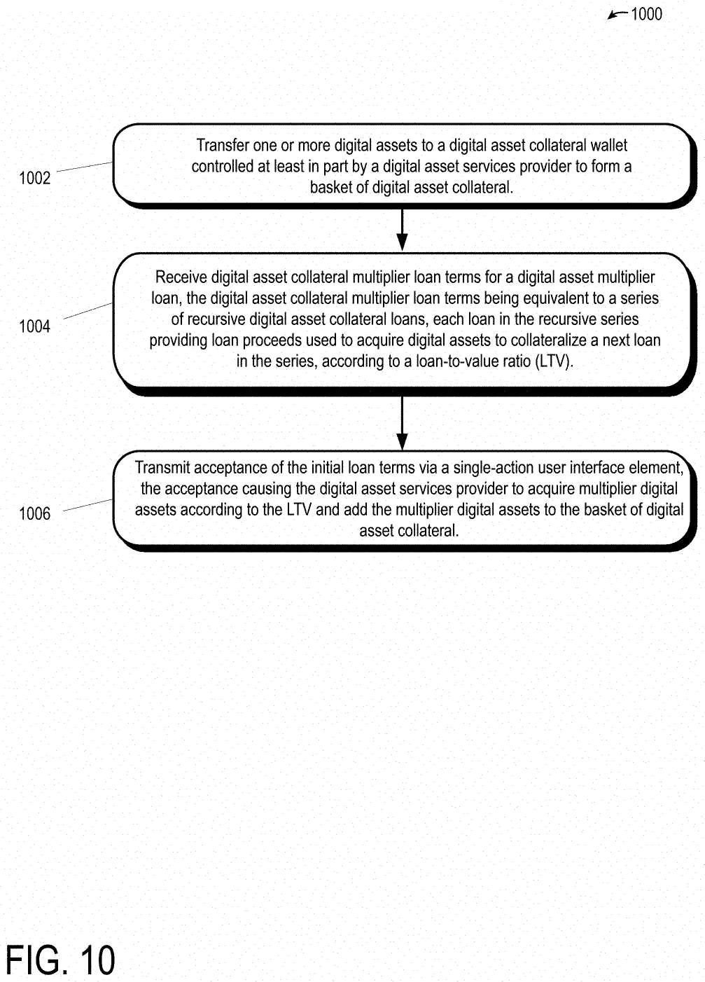

FIG. 10 is an example workflow 1000 of a method of automatically multiplying digital asset collateral of a loan. A transferring operation 1002 transfers one or more digital assets to a digital asset collateral wallet controlled at least in part by a digital asset services provider to form a basket of digital asset collateral. A receiving operation receives digital asset collateral multiplier loan terms for a digital asset multiplier loan, the digital asset collateral multiplier loan terms being equivalent to a series of recursive digital asset collateral loans, each loan in the recursive series providing loan proceeds used to acquire digital assets to collateralize a next loan in the series, according to a loan-to-value ratio (LTV). A transmitting operation transmits acceptance of the initial loan terms via a single-action user interface element, the acceptance causing the digital asset services provider to acquire multiplier digital assets according to the LTV and add the multiplier digital assets to the basket of digital asset collateral.

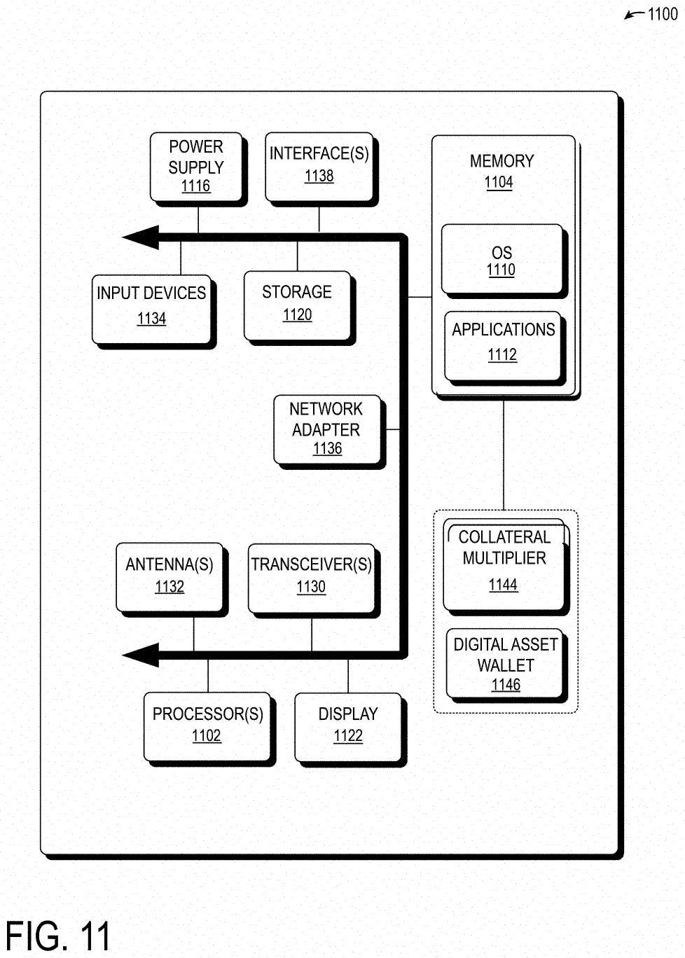

FIG. 11 is an example system 1100 that may be useful in carrying out the present disclosure. FIG. 11 illustrates an example system (labeled as a processing system 1100) that may be useful in implementing the described technology. The processing system 1100 may be a client device, such as a smart device, connected device, Internet of Things (IoT) device, laptop, mobile device, desktop, tablet, or a server/cloud device. The processing system 1100 includes one or more processor(s) 1102, and a memory 1104. The memory 1104 generally includes both volatile memory (e.g., RAM) and non-volatile memory (e.g., flash memory). An operating system 1110 resides in the memory 1104 and is executed by the processor 1102.

One or more application programs 1112 modules or segments, such as collateral multiplier 1144 and digital asset wallet 1146 are loaded in the memory 1104 and/or storage 1120 and executed by the processor 1102. In some implementations, the collateral multiplier 1144 is stored in read only memory (ROM) 1114 or write once, read many (WORM) memory. Data such as loan terms may be stored in the memory 1104 or storage 1120 and may be retrievable by the processor 1102 for use by collateral multiplier 1144 and the digital asset wallet 1146, etc. The storage 1120 may be local to the processing system 1100 or may be remote and communicatively connected to the processing system 1100 and may include another server. The storage 1120 may store resources that are requestable by client devices (not shown). The storage 1120 may include secure storage such as one or more platform configuration registers (PCR) manages by one or more trusted platform modules (TPMs), which may be implanted in a chip or by the trusted execution environment TEE.

The processing system 1100 includes a power supply 1116, which is powered by one or more batteries or other power sources and which provides power to other components of the processing system 1100. The power supply 1116 may also be connected to an external power source that overrides or recharges the built-in batteries or other power sources.

The processing system 1100 may include one or more communication transceivers 1130 which may be connected to one or more antenna(s) 1132 to provide network connectivity (e.g., mobile phone network, Wi-Fi®, Bluetooth®, etc.) to one or more other servers and/or client devices (e.g., mobile devices, desktop computers, or laptop computers). The processing system 1100 may further include a network adapter 1136, which is a type of communication device. The processing system 1100 may use the network adapter 1136 and any other types of communication devices for establishing connections over a wide-area network (WAN) or local area network (LAN). It should be appreciated that the network connections shown are exemplary and that other communications devices and means for establishing a communications link between the processing system 1100 and other devices may be used.

The processing system 1100 may include one or more input devices 1134 such that a user may enter commands and information (e.g., a keyboard or mouse). Input devices 1134 may further include other types of input such as multimodal input, speech input, graffiti input, motion detection, facial recognition, physical fingerprinting, etc. These and other input devices may be coupled to the server by one or more interfaces 1138 such as a serial port interface, parallel port, universal serial bus (USB), etc. The processing system 1100 may further include a display 1122 such as a touch screen display.

The processing system 1100 may include a variety of tangible processor-readable storage media and intangible processor-readable communication signals including in virtual and/or cloud computing environment. Tangible processor-readable storage can be embodied by any available media that can be accessed by the processing system 1100 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing system 1100. In contrast to tangible processor-readable storage media, intangible processor-readable communication signals may embody computer-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Of course, the applications and benefits of the systems, methods and techniques described herein are not limited to only the above examples. Many other applications and benefits are possible by using the systems, methods and techniques described herein.

Furthermore, when implemented, any of the methods and techniques described herein or portions thereof may be performed by executing software stored in one or more non-transitory, tangible, computer readable storage media or memories such as magnetic disks, laser disks, optical discs, semiconductor memories, biological memories, other memory devices, or other storage media, in a RAM or ROM of a computer or processor, etc.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of offering a single digital asset collateral multiplier loan equivalent to a recursive series of digital asset collateral loans, the method comprising:
receiving one or more types of digital asset collateral from a borrower to yield a basket of digital asset collateral, the basket of digital asset collateral having a combined market value;
transmitting a set of digital asset collateral multiplier loan terms to the borrower, the set of collateral multiplier loan terms being equivalent to a recursive series of digital asset collateralized loans, wherein proceeds from each loan in the series collateralize a next loan in the series, the collateral multiplier loan terms further including loan-to-value ratio (LTV) terms;
receiving an acceptance from the borrower of the collateral multiplier loan terms via a single-action user interface element;
acquiring multiplier digital asset collateral to add to the basket of digital asset collateral, the combined market value of the basket of digital asset collateral being sufficient to satisfy the LTV term of the collateral multiplier loan terms after addition of the multiplier digital asset collateral; and
receiving multiplier loan proceeds from a lender.

2. The method of claim 1, wherein the operation that receives the acceptance of the multiplier loan terms from the borrower includes the borrower clicking a single-button multiplier loan request.

3. The method of claim 1, wherein the multiplier loan proceeds substantially equal
$$\frac{1}{1 - L T V} .$$

4. The method of claim 1, wherein the operation that acquires the multiplier digital asset collateral occurs before the operation that receives multiplier loan proceeds from the lender and includes providing credit to the borrower for a period until the operation that receives the multiplier loan proceeds is complete.

5. The method of claim 1, wherein the operation that receives the multiplier loan proceeds is before the operation that acquires the multiplier digital asset collateral, the operation that receives the multiplier loan proceeds being under agreement with the lender to use the multiplier loan proceeds for the operation that acquires the multiplier digital asset collateral.

6. The method of claim 1, further comprising:
determining whether at least a portion of the basket of digital asset collateral satisfies a staking requirement on a digital asset network;
receiving instructions from the borrower to stake the at least of portion of the basket of digital asset collateral on the digital asset network;
staking the at least a portion of the basket of digital asset collateral on the digital asset network; and
disbursing staking rewards from the staking operation to the basket of digital asset collateral.

7. A system for managing an automatic digital asset collateral multiplication loan, the system comprising:
a digital asset collateral wallet to control a basket of digital asset collateral;
a transmitter for communicating multiplier loan terms to a borrower, the multiplier loan terms being equivalent to a series of recursive digital asset collateral loans, each loan in the series providing loan proceeds to acquire digital assets to collateralize a next loan in the series, and including an LTV term being based at least in part on the basket of digital asset collateral;
a single-action digital asset multiplier user interface element for accepting the multiplier loan terms;
a lender link to communicate the acceptance by the borrower of the multiplier loan terms and to receive multiplier loan proceeds;
a trader that acquires digital asset multiplier collateral on behalf of the borrower to collateralize the digital asset multiplication loan and adds the digital asset multiplier to the basket of digital asset collateral; and
a loan health monitor to periodically verify a health of the digital asset multiplier loan to yield a current LTV and alert the borrower if the current LTV satisfies an alert condition.

8. The system of claim 7, wherein the loan health monitor determines the current LTV satisfies a liquidation condition and the trader liquidates at least a portion of the basket of digital asset collateral such that the health of the digital asset multiplier loan no longer satisfies the liquidation condition.

9. The system of claim 7, further comprising:
a digital asset digital rights manager that determines whether at least a portion of the basket of digital asset collateral satisfies a digital rights condition on a blockchain, the digital asset rights manager receiving digital rights instructions from the borrower, the digital asset rights manager further executing the digital rights instructions by signing a transaction on the blockchain exercising digital rights according to the digital rights instructions.

10. The system of claim 9, wherein the digital rights are voting rights and the digital rights instructions include voting preferences.

11. The system of claim 9, wherein the digital rights are staking rights, and the digital asset rights manager periodically adds staking rewards earned according to the digital rights instructions to the basket of digital asset collateral.

12. The system of claim 9, wherein the digital rights include authority to operate a masternode and the digital rights instructions include masternode parameters.

13. The system of claim 7, further comprising:
a fiat currency storage to supply funds used by the trader to acquire the multiplier digital asset collateral and receive digital asset collateral loan proceeds from the lender.

14. The system of claim 9, wherein the digital asset digital rights manager requests digital rights instructions from the borrower depending at least in part on the basket of digital asset collateral satisfying the digital rights condition on the blockchain.

15. A method of automatically multiplying digital asset collateral of a loan, the method comprising:
transferring one or more digital assets to a digital asset collateral wallet controlled at least in part by a digital asset services provider to form a basket of digital asset collateral;
receiving digital asset collateral multiplier loan terms for a digital asset multiplier loan, the digital asset collateral multiplier loan terms being equivalent to a series of recursive digital asset collateral loans, each loan in the recursive series providing loan proceeds used to acquire digital assets to collateralize a next loan in the series, according to a loan-to-value ratio (LTV); and
transmitting acceptance of the digital asset collateral multiplier loan terms via a single-action user interface element, the acceptance causing the digital asset services provider to acquire multiplier digital assets according to the LTV and add the multiplier digital assets to the basket of digital asset collateral.

16. The method of claim 15, wherein a market value of the multiplier digital asset collateral substantially equals
$$\frac{1}{1 - L T V}$$
times a market value of the basket of digital asset collateral before the multiplier digital asset collateral is added thereto.

17. The method of claim 15, further comprising:
receiving a cryptographic spending key to the digital asset collateral wallet, the digital asset collateral wallet being a multisig wallet.

18. The method of claim 15, further comprising:
transmitting a request to the digital asset services provider to rebalance the digital assets in the basket of digital asset collateral according to rebalancing instructions.

19. The method of claim 15, further comprising:
receiving a notification that at least one digital asset in the basket of digital asset collateral satisfies a digital rights condition; and
transmitting digital rights exercise instructions to the digital asset services provider regarding the at least one digital asset in the basket of digital asset collateral.

20. The method of claim 15, further comprising:
receiving an alert notification that the digital asset multiplier loan satisfies a liquidation condition; and
receiving a portion of a value equivalent to a remainder portion of the basket of digital asset collateral after at least a portion of the basket of digital asset collateral has been liquidated to extinguish the multiplier loan.
